(19) United States
(12) Patent Application Publication
(10) Pub. No.: US 2007/0262075 A1
(43) Pub. Date: Nov. 15, 2007

(54) Heat Plate for Welding the Pipe with Multi-Walls and the Method for Welding the Same

(76) Inventors: Bo-Young Lee, Goyang-si (KR); Duck-Hee Ryu, Seoul (KR)

Correspondence Address: IPLA P.A., 3580 WILSHIRE BLVD., 17TH FLOOR, LOS ANGELES, CA, 90010, US

(21) Appl. No.: 11/573,268

(22) PCT Filed: Aug. 4, 2005
(86) PCT No.: PCT/KR05/02534

§ 371 Date: Feb. 5, 2007

(30) Foreign Application Priority Data
Aug. 5, 2004 (KR) 10-2004-0061578

(51) Int. Cl. B29C 65/18

(52) U.S. Cl. 219/600

(57) ABSTRACT

Disclosed herein is a device and method, preventing water from leaking to the outside of a multiple wall pipe, or a hollow part in a pipe wall, and forcibly correcting differences in inside and outside diameters between pipes provided on opposite ends of a joint, and simultaneously correcting circularity of the pipe. The heat plate includes a disc, a circular groove provided on an outer surface of a side of the disc and having a V-shaped cross-section with a flat bottom, and a heat source inserted in the disc. A method of joining a multiple wall pipe includes inserting an end of the cut multiple wall pipe into a V-shaped groove of the heat plate, heating and fusing the end of the cut multiple wall pipe by applying electricity to the heat plate, and compressing and cooling the cut multiple wall pipe after the heat plate is removed.

### TECHNICAL FIELD

The present invention relates to a device and method capable of preventing water from leaking to the outside of a multiple wall pipe, including a double wall pipe, or a hollow part in a wall of a spirally wound pipe, and forcibly correcting differences in inside and outside diameters between pipes provided on opposite ends of a joint, in addition to simultaneously correcting circularity of the pipe.

### BACKGROUND ART

Among polyethylene (PE) pipes for sewer pipes, a multiple wall pipe, such as a spiral double wall pipe, a spiral triple wall pipe, or a spiral PE double wall solid pipe, has been frequently used. Since such a spiral double wall pipe is cut to a predetermined length, cut ends must be joined together during construction.

In the case of a PE double wall pipe for sewer pipes, a definite national standard for a pipe manufacturing and joining method has not been established, unlike a city gas pipe or a waterworks pipe, which is made of the same material. Even though products having the same pipe diameter are produced, inside and outside diameters of the products which are produced by different manufacturing companies are substantially different from each other. Thus, it is difficult to join the products produced by several companies through the butt-joint method.

Even if products are manufactured at the same factory, the diameters of the products may be considerably different from each other according to manufacturing conditions (temperature during a cooling process), due to the properties of the material of the products. Table 1 shows the dimension and tolerance of a sealed double pipe, which are prescribed in the Korea plastic standards (KPS M2009).

TABLE 1
Dimension and tolerance of B-type sealed double pipe(unit: mm)

| | tolerance | minimum pipe | | minimum | |
|---|---|---|---|---|---|
| | for mean | wall thickness | | thickness | |
| Mean inside | inside | first | second | of bell | Length |
| diameter | diameter | class | class | part | (m) |
| 100 | ±4.0 | | | 5.1 | 4 or 6 |
| 125 | ±4.0 | | | 5.5 | |
| 150 | ±4.5 | | | 5.9 | |
| 200 | ±5.1 | 14 | 12 | 7.4 | |
| 250 | ±5.1 | 15 | 14 | 8.4 | |
| 300 | ±5.1 | 19 | 14 | 9.1 | |
| 350 | ±5.1 | 22 | 15 | 10.7 | |
| 400 | ±5.1 | 25 | 19 | 12.7 | |
| 450 | ±5.1 | 29 | 22 | 12.7 | |
| 500 | ±5.1 | 31 | 25 | 12.7 | |
| 600 | ±5.1 | 39 | 31 | 12.7 | |

As shown in Table 1, the diameter of a pipe used as a sewer pipe is generally 200˜600 mm, and tolerance for a mean inside diameter of the pipe is ±5.1 mm. In the case of the pipe that is actually produced, the pipe may not be perfectly circular. Thus, when pipes are joined together through a butt-joint welding method, the maximum difference is 10.2 mm or more.

Further, since a double wall pipe is a spiral pipe, the shape of cut ends is not constant, even if the pipe is vertically cut. That is, the shape of cut parts may vary, as shown in FIG. 1. When the double wall pipe is cut as shown in FIGS. 1a and 1b, a solid part is present, thus allowing pipes to be easily joined to each other. However, when the double wall pipe is cut as shown in FIG. 1c, a hole is formed. In this case, ends having holes cannot be satisfactorily joined to each other using a general butt-joint welding method.

In order to solve the problem and meet required tolerance, various technologies have been developed.

To date, various kinds of PE pipe joining methods have been widely used in Korea. For example, a PE sleeve socket joining method, a PE circular socket joining method, a stainless band socket joining method, an electro-fusion sheet joining method, a flange joining method, a sealed double wall joining method, etc. have been proposed, which may be given slightly different names by PE pipe manufacturers and sewer coupling companies.

However, all construction methods used at present may cause land to sink if constructed pipes are used for a lengthy period of time, so that the methods do not provide reliable durability. Further, it is uncertain whether the construction methods meet a joint watertightness test requirement specified in the Korea Plastic Standards (KPS M2009). According to the joint watertightness test requirement, when both ends of a pipe are sealed and the pipe is filled with water or gas, the pipe must maintain pressure of 0.75 kgf/cm² for 10 minutes, and the internal pressure of the pipe must not be changed to exceed 0.17 kgf/cm².

The construction methods used at present will be described in brief with reference to FIG. 2.

FIG. 2a shows an electro-fusion joining method which is one of the methods that are widely used at present. According to this method, a sheet 2 is placed on outer surfaces of double wall pipes 1 to join the pipes 1 together. However, this method is problematic in that an additional pipe joining member, such as a fusion sheet, a stainless band, or a thermal-contraction sleeve, must be used, so that construction thereof is complicated.

Further, the electro-fusion joining method is problematic in that it is impossible to prevent leakage due to corrosion, even if the pipes are joined together using a corrosion-resistant material. Since the pipes are joined together only at outer surfaces thereof, leakage may frequently occur. All processes of the method are manually carried out, so that it is impossible to realize automation of the method.

FIG. 2b shows a flange joining method wherein a flange 3 is fastened to ends of double wall pipes 1 using a bolt and a nut, thus joining the pipes together. The flange joining method is problematic in that the double wall pipes are joined together by fusing a one-layer pipe to the double wall pipes, so that a sewer pipe produced through this method is expensive, and leakage may occur due to corrosion if the flange 3 is fastened using bolts and nuts.

FIG. 2c shows a sealed double wall butt-joint method. In order to realize the butt-joint, a filler 4 is charged between joined parts of the pipes. This method affords excellent watertightness, strength, and durability. However, the method is problematic in that a sewer pipe is expensive.

FIG. 2d shows a thermal fusion method. According to this method, a heat plate 5 is manufactured so as to forcibly correct the difference in pipe diameter and cause joined surfaces to form a solid wall. However, when the difference between pipe diameters is large, a step is generated between the two pipes. Such a step existing in the pipes causes leakage through hollow parts in the double walls. Thus, even though water does not leak outside the pipes, the pipes may freeze and burst in winter. Further, when a pipe is considerably different from perfect circularity, it is impossible to join pipes.

### DISCLOSURE OF THE INVENTION

### Technical Tasks to be Solved by the Invention

Accordingly, the present invention has been made keeping in mind the above problems occurring in the prior art, and an object of the present invention is to provide a device and method capable of preventing water from leaking to the outside of a multiple wall pipe, including a double wall pipe, or a hollow part in a wall of a spirally wound pipe, and forcibly correcting differences in inside and outside diameters between pipes provided on opposite ends of a joint, in addition to simultaneously correcting circularity of the pipe. Another object of the present invention is to provide a device and method, which makes a proper groove on a heat plate, thus preventing misalignment of pipes due to dimensional variation of each multiple wall pipe, and which increases the thickness of joined ends, thus increasing a joining strength.

### TECHNICAL SOLUTION

In order to accomplish the objects, the present invention provides a heat plate for joining a multiple wall pipe, including a circle- or ring-shaped plate, a circular groove provided on an outer surface of each side of the plate and having a V-shaped cross-section with a flat bottom, and a heat source inserted in the plate.

Further, this invention provides a heat plate having a V-shaped groove with a step.

Further, this invention provides a heat plate having a two lined V-shaped groove so that a cut end of a double wall pipe is fitted into the groove.

Furthermore, the present invention provides a method of joining a multiple wall pipe using a heat plate, including the steps of inserting an end of the cut multiple wall pipe into a V-shaped groove of the heat plate for joining the multiple wall pipe, heating and fusing the end of the cut multiple wall pipe by applying electricity to the heat plate, and compressing and cooling the cut multiple wall pipe after the heat plate is removed.

### ADVANTAGEOUS EFFECTS

According to the present invention, a cut end of a multiple wall pipe precisely corresponds to a groove of a heat plate, thus preventing misalignment due to dimensional variation of the pipe, and the area of a joined surface is increased, thus increasing joining strength.

### BRIEF DESCRIPTION OF DRAWINGS

FIG. 1 is a view to show cut ends of a spiral double wall pipe;

FIG. 2 illustrates conventional methods of joining double wall pipes;

FIG. 3 is a perspective view of a heat plate used for joining multiple wall pipes, according to an embodiment of the present invention;

FIG. 4 is a schematic view of a heat plate, according to another embodiment of this invention;

FIG. 5 illustrates embodiments of V-shaped grooves of the present invention;

FIG. 6 is a sectional view to show the state where the heat plate of FIG. 4 is assembled; and

FIG. 7 is a photograph to show a method of joining multiple wall pipes, using the device of this invention.

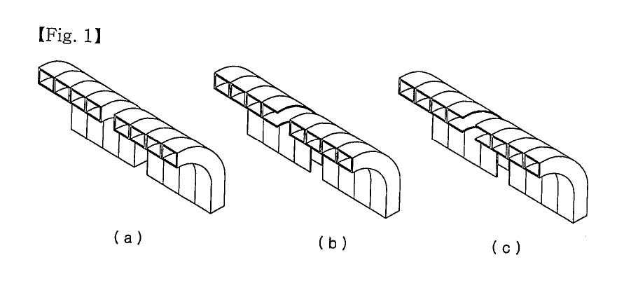

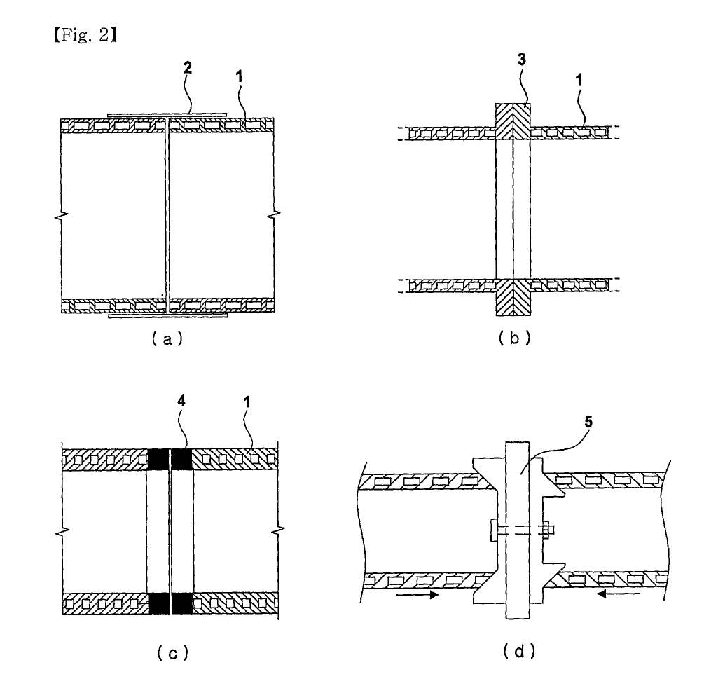

### BEST MODE FOR CARRYING OUT THE INVENTION

Hereinafter, the present invention will be described in detail with reference to the accompanying drawings.

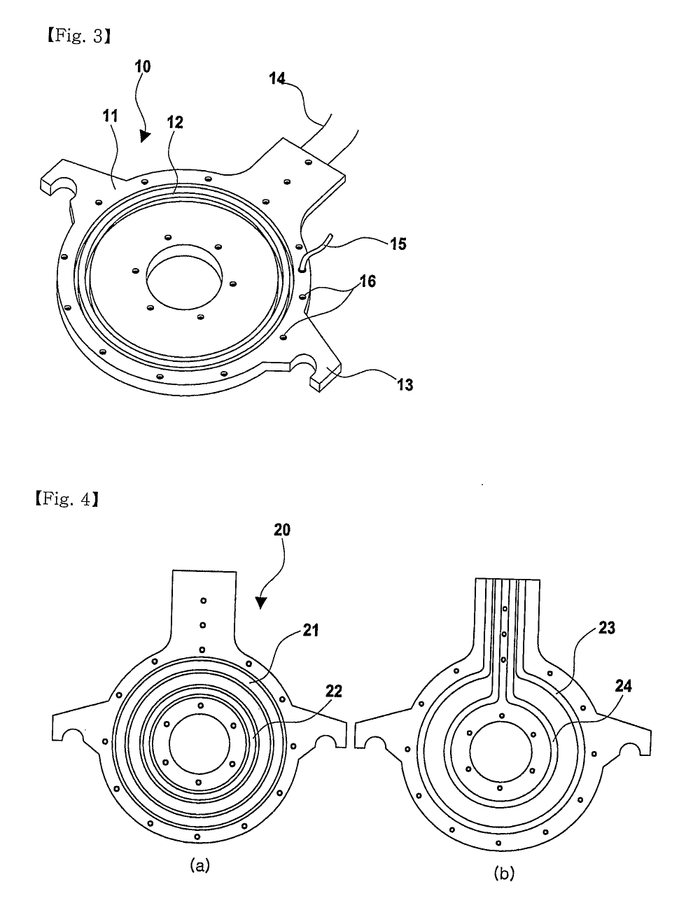

FIG. 3 is a perspective view to show a device, according to an embodiment of this invention.

A heat plate 10 of this invention includes a main body 11 having the shape of a disc or a ring. A circular groove 12 having a V-shaped cross-section with a flat bottom is formed on the main body 11. Hook parts 13 are provided on both sides of the main body 11, and are hooked to a support shaft of a pipe aligning device.

In order to reduce the weight of the heat plate 10, the heat plate 10 is manufactured using aluminum alloy. The outer surface of the heat plate 10 may be coated with Teflon so as to prevent polyethylene or impurities from adhering to the heat plate 10.

A heat source is inserted into the main body 11. A power line 14, which is connected to a power source for heating the heat source, is connected to the main body 11. Further, a thermocouple 15 is provided at a predetermined position on the main body 11, and detects the temperature of the heat plate 10. The thermocouple 15 is connected to a temperature controller (not shown), thus automatically controlling the temperature of the heat plate 10.

For easy treatment of the temperature controller (not shown), it is more preferable that the thermocouple be inserted into the heat plate and be integrally provided on an upper portion of the heat plate.

According to the embodiment of FIG. 3, the main body 11 comprises two sheets so that the heat source is inserted into the main body 11. The sheets of the main body 11 are coupled to each other by tightening bolts and nuts into bolt holes 16, thus providing the heat plate.

Further, according to another embodiment, it is more preferable that a main body 11 having a heat source therein be produced in the form of a casting, and that V-shaped grooves subsequently be formed on the outer surface of the main body.

FIG. 4a shows the outer surface of a device, according to another embodiment of this invention, and FIG. 4b shows the interior of the device.

As shown in FIG. 4a, two kinds of grooves, that is, a groove 21 for a larger-diameter pipe and a groove 22 for a smaller-diameter pipe, are formed on the main body. Further, as shown in FIG. 4b, a heat source 23 is installed in a heat plate 20 to heat the groove for the larger-diameter pipe, and another heat source 24 is installed in the heat plate 20 to heat the groove for the smaller-diameter pipe. A pipe heater having a proper capacity is preferably used as the heat source, but is not limited to a specific heat source.

A general larger-diameter pipe has a diameter of 300 mm, and a general smaller-diameter pipe has a diameter of 200 mm.

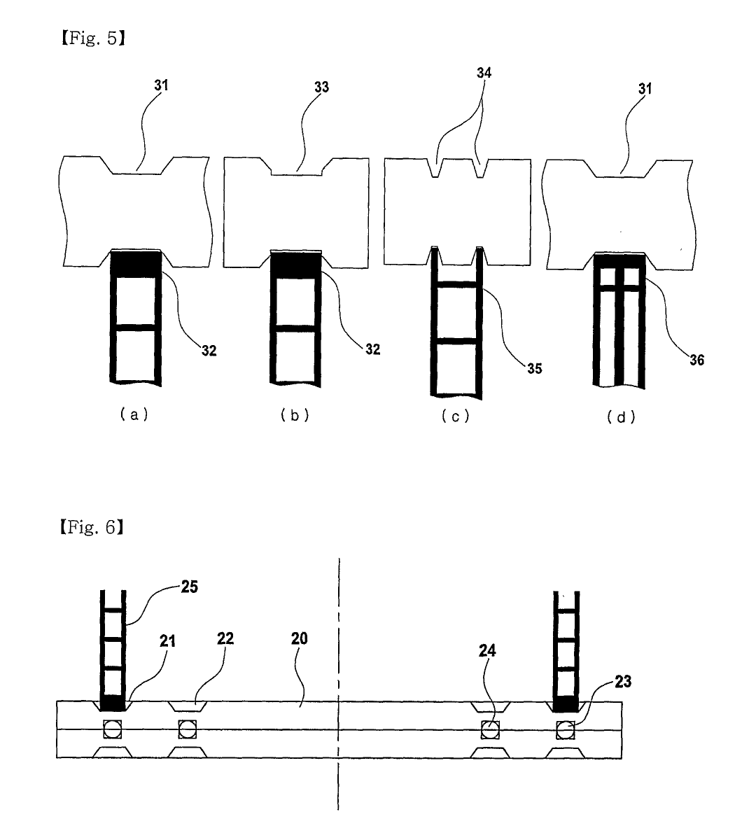

FIG. 5 illustrates embodiments of V-shaped grooves of this invention.

FIG. 5a is a view to show a V-shaped groove 31 with a flat bottom. A heat plate having the groove fuses and fills a hollow part of a wall of a PE pipe, thus allowing pipes to be easily joined together. FIG. 5b shows a V-shaped groove 33 which is flat at the bottom thereof but has a step. Similar to the heat plate having the groove 31, a heat plate having the groove 33 fuses and fills a hollow part of a wall of a pipe, thus allowing pipes to be joined together. This affords a more reliable filling, in comparison with the heat plate having the groove 31.

FIG. 5c shows a V-shaped groove 34 which is flat at the bottom thereof and comprises two lines. This is suitable for joining pipe walls together without filling a cut end.

FIG. 5d shows a method of joining a triple wall pipe. In FIG. 5d, the triple wall pipe 36 is welded using a heat plate having the V-shaped groove 31 which is equal to that of FIG. 5a.

FIG. 6 is a sectional view to show the state where the heat plate of FIG. 4 has been assembled.

A larger-diameter double wall pipe 25 is inserted into the V-shaped groove 21 of the heat plate 20, and the heat sources 23 and 24 are provided in the heat plate 20.

Hereinafter, the process of joining the multiple wall pipe using the heat plate of this invention will be described with reference to the accompanying drawing.

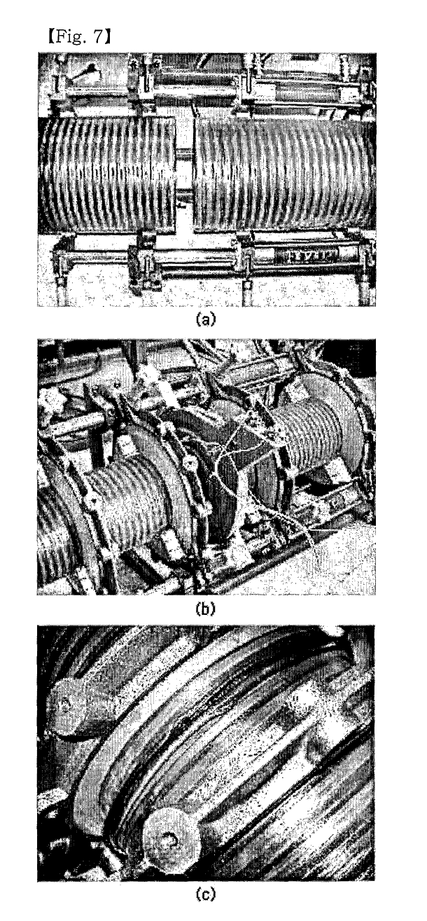

FIG. 7 is a photograph to show the method of joining the multiple wall pipe using the device of this invention.

The joining process includes a pipe aligning step-a heat plate inserting step-a compressing and fusing step-a heat maintaining step-a heat plate removing step-a compressing and cooling step.

FIG. 7a shows the state where pipes are aligned using a general pipe aligning device, FIG. 7b shows the state of inserting the heat plate, and compressing and fusing the pipes, and FIG. 7c shows the state of compressing and cooling the fused pipe.

The optimum temperature for fusing a PE pipe is 210° C. or so, and the optimum pressure for fusing a PE pipe is 1.5 kg/cm². Heating time varies according to pipe diameter. It is most desirable to heat the PE pipe until the fused PE pipe forms beads of 2˜3 mm on the outer portion of the pipe.

1. A heat plate for joining a multiple wall pipe. comprising:
a circle- or ring-shaped plate:
a circular groove provided on an outer surface of each side of the plate, and having a V-shaped cross-section with a flat bottom; and
a heat source inserted in the plate.

2. The heat plate according to claim 1, wherein the V-shaped groove comprises a V-shaped groove (33) having a step.

3. The heat plate according to claim 1, wherein the V-shaped groove comprises a two lined V-shaped groove (34) so that a cut end of a double wall pipe is fitted into the groove.

4. A method of joining a multiple wall pipe using a heat plate, comprising the steps of:
inserting an end of the cut multiple wall pipe into a V-shaped groove of the heat plate for joining a multiple wall pipe including a circle- or ring-shaped plate, a circular groove provided on an outer surface of each side of the plate, and having a V-shaped cross-section with a flat bottom and a heat source inserted in the plate;
heating and fusing the end of the cut multiple wall pipe by applying electricity to the heat plate; and
compressing and cooling the cut multiple wall pipe after the heat plate is removed.
